(19) United States
(12) Patent Application Publication
(10) Pub. No.: US 2001/0035851 A1
(43) Pub. Date: Nov. 1, 2001

(54) Liquid crystal display apparatus

(76) Inventors: Mikihiro Komatsu, Ibaraki-Shi (JP); Tsukasa Yagi, Kobe-Shi (JP); Katsuyuki Nanba, Sakai-Shi (JP)

Correspondence Address: SIDLEY AUSTIN BROWN & WOOD, 717 NORTH HARWOOD, SUITE 3400, DALLAS, TX, 75201, US

(21) Appl. No.: 09/817,688

(22) Filed: Mar. 26, 2001

(30) Foreign Application Priority Data
Mar. 29, 2000 (JP) 2000-090559

(51) Int. Cl. G09G 3/36

(52) U.S. Cl. 345/87

(57) ABSTRACT

Disclosed is a liquid crystal display apparatus comprising: a liquid crystal display element having a plurality of liquid crystal layers each having a plurality of display units that are arranged in a matrix fashion and are defined by intersections of a plurality of scanning line electrodes and a plurality of data line electrodes, said liquid crystal layers being stacked each other such that said scanning line electrodes and said data line electrodes of any one of said liquid crystal layers match said scanning line electrodes and said data line electrodes of the other ones of said liquid crystal layers whereby a plurality pixels are formed by the display units of each liquid crystal layer that overlap with each other; and a controller for, when an image is drawn in said liquid crystal display element, selecting at least one of the matching scanning line electrodes of said liquid crystal layers at a different timing than that used for the other matching scanning line electrodes, such that the all of the matching scanning line electrodes of said liquid crystal layers are not simultaneously selected.

### CROSS-REFERENCE TO RELATED APPLICATION

This application is based on Japanese Patent Application No.2000-090559 filed in Japan on Mar. 29, 2000, the entire content of which is hereby incorporated by reference.

### BACKGROUND OF THE INVENTION

1. Field of the Invention

The present invention relates to a liquid crystal display apparatus having a liquid crystal display element comprising multiple liquid crystal layers stacked together and to a driving method thereof, and more particularly, to a liquid crystal display apparatus that comprises multiple liquid crystal layers stacked together and that can display multi-color images, and to an interlace driving method thereof.

2. Description of the Related Art

Liquid crystal apparatuses using so-called memory type liquid crystal (e.g., chiral nematic liquid crystal) have been proposed that can maintain a specific phase or molecular orientation even when no power is being supplied thereto. While a liquid crystal apparatus of this type can maintain the displayed images without the supply of power, it is slow in response (in other words, the required response time between the commencement of power supply and the appearance of the desired colors is long). In order to speed up to the extent possible redrawing of the display image in this liquid crystal apparatus, a drive method called dynamic driving has been proposed. Furthermore, in an effort to cause liquid crystal apparatuses of this type to display moving images, dynamic driving could be performed with the adoption of the scanning method generally adopted in the area of television image engineering (the interlaced scanning method). In the above dynamic driving, three different periods, i.e., a reset period, a selection period and a maintenance period, are needed in order to redraw display units on one scanning line. By sequentially selecting each scanning line, the entire display may be redrawn. In addition, by selecting only some scanning lines, the image corresponding to the selected area only may be redrawn as well.

However, during the above dynamic driving, while a scanning line is being accessed, i.e., during the above reset period, selection period and maintenance period, the display units on that scanning line cannot contribute to image display, and therefore the background color (normally black, which is the color of the light absorbing layer) is observed in this scanning line. Consequently, where the scanning lines are sequentially selected, a belt of the background color is observed over multiple scanning lines, and as the scanning progresses, this belt also moves. Where dynamic driving is performed using the interlaced scanning method, a belt having a width equivalent to multiple lines does not appear, but multiple belts each having a width equal to one line appear in the display. In particular, where the displayed images are continuously redrawn in order to reproduce moving images, the above-mentioned belts of the background color are observed at all times, significantly reducing the ease of image viewing.

### SUMMARY OF THE INVENTION

Therefore, an object of the present invention is to provide a new liquid crystal display apparatus that can eliminate reduction in the ease of image viewing when dynamic driving is carried out.

Another object of the present invention is to provide a liquid crystal display apparatus that can prevent reduction in the ease of image viewing when driving is performed wherein image updating is continuously performed in order to reproduce moving images.

In order to attain at least one of these objects, a liquid crystal display apparatus reflecting one aspect of the present invention comprising: a liquid crystal display element having a plurality of liquid crystal layers each having a plurality of display units that are arranged in a matrix fashion and are defined by intersections of a plurality of scanning line electrodes and a plurality of data line electrodes, said liquid crystal layers being stacked each other such that said scanning line electrodes and said data line electrodes of any one of said liquid crystal layers match said scanning line electrodes and said data line electrodes of the other ones of said liquid crystal layers whereby a plurality pixels are formed by the display units of each liquid crystal layer that overlap with each other; and a controller for, when an image is drawn in said liquid crystal display element, selecting at least one of the matching scanning line electrodes of said liquid crystal layers at a different timing than that used for the other matching scanning line electrodes, such that the all of the matching scanning line electrodes of said liquid crystal layers are not simultaneously selected.

In this liquid crystal display apparatus, because the matching scanning line electrodes of the liquid crystal layers are prevented from being selected at the same time, if the pixels on a certain scanning line are viewed, at least one liquid crystal layer is contributing to the display, such that belts of the background color are no longer observed.

In the above liquid crystal display apparatus, the controller may include wiring that connects the drive circuits and the scanning line electrodes of each of the above liquid crystal layers.

In the above liquid crystal display apparatus, the controller may include a scanning driver that is shared by at least two of the liquid crystal layers. In this case, the above scanning driver may be shared by all of the liquid crystal layers.

In the above liquid crystal display apparatus, at least one of the liquid crystal layers may be placed such that it is offset from the other liquid crystal layers by one scanning line electrode in the direction of the alignment thereof.

In the above liquid crystal display apparatus, the controller may select each of the matching scanning line electrodes of the multiple liquid crystal layers at different timings.

In the above liquid crystal display apparatus, the controller may split the multiple liquid crystal layers into multiple fields for driving.

According to another aspect of the present invention, a liquid crystal display apparatus comprising: a liquid crystal display element comprising a plurality of liquid crystal layers that are stacked each other; a drive circuit for driving the liquid crystal layers; and a control unit that is connected to said drive circuit and is adapted to update information displayed on said liquid crystal display element by using an interlaced scanning method that divides each liquid crystal layer into a plurality of fields and sequentially drives the fields of each liquid crystal layer, wherein said control unit controls said driver so that a driven field of at least one of said liquid crystal layers different from those of the other of said liquid crystal layers.

### BRIEF DESCRIPTION OF THE DRAWINGS

These and other objects, advantages and features of the invention will become apparent from the following description thereof taken in conjunction with the accompanying drawings in which:

FIG. 1 is a cross-sectional view showing the basic construction of the liquid crystal apparatus pertaining to an embodiment 1;

FIG. 2 is a drawing showing in a simplified fashion the placement of the scanning line electrodes and the data line electrodes in the liquid crystal apparatus shown in FIG. 1;

FIG. 3 is a block diagram showing the basic construction of the liquid crystal apparatus shown in FIG. 1;

FIG. 4 is a block diagram showing the basic construction of the scanning line driver in the liquid crystal apparatus shown in FIG. 1;

FIG. 5 is a drawing to explain the interlace driving in the liquid crystal apparatus shown in FIG. 1;

FIG. 6 is a drawing showing the relationships among the scanning line shift clock, the scanning line latch signal and the data line drive signal in the liquid crystal apparatus shown in FIG. 1;

FIG. 7 is a cross-sectional view showing the basic construction of the liquid crystal apparatus pertaining to an embodiment 2;

FIG. 8 is a basic plan view of the liquid crystal apparatus shown in FIG. 7;

FIG. 9 is a drawing to explain the interlace driving of the liquid crystal apparatus shown in FIG. 7;

FIG. 10 is a block diagram showing the basic construction of the liquid crystal apparatus shown in FIG. 7;

FIG. 11 is a drawing showing the relationships among the scanning line shift clock, the scanning line latch signal and the data line drive signal in the liquid crystal apparatus shown in FIG. 7;

FIG. 12 is a cross-sectional view showing the basic construction of the liquid crystal apparatus pertaining to an embodiment 3;

FIG. 13 is a basic plan view of the liquid crystal apparatus shown in FIG. 12;

FIG. 14 is a drawing to explain the interlace driving of the liquid crystal apparatus shown in FIG. 12;

FIG. 15 is a block diagram showing the basic construction of the liquid crystal apparatus shown in FIG. 12; and

FIG. 16 is a drawing showing the relationships among the scanning line shift clock, the scanning line latch signal and the data line drive signal in the liquid crystal apparatus shown in FIG. 12.

### DETAILED DESCRIPTION OF THE PREFERRED EMBODIMENTS

Multiple embodiments of the present invention are explained below with reference to the accompanying drawings. In the accompanying drawings, the same or similar components are assigned the same numbers. In addition, in the following explanation, directional terms (such as ‘up’, ‘down’, ‘right’, ‘left’ and other terms including these terms) are used from time to time in order to facilitate understanding, but the scope of the present invention is not limited by these terms.

Embodiment 1

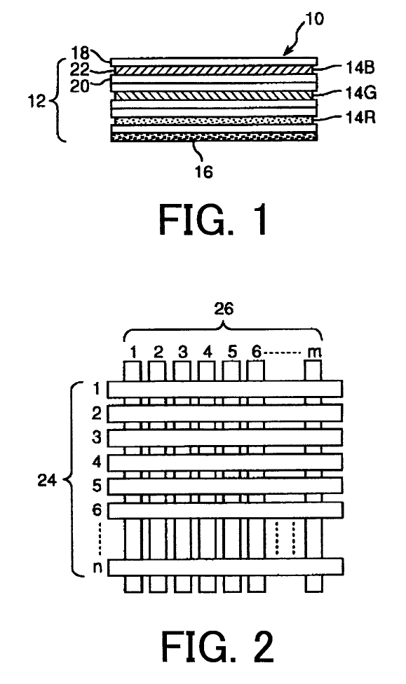

FIG. 1 is a simplified drawing to explain the basic cross-sectional construction of a reflection-type liquid crystal display apparatus. As shown in this drawing, the liquid crystal display apparatus 10 has a liquid crystal display element 12. The liquid crystal display element 12 has three liquid crystal layers 14 (a blue liquid crystal layer 14B, a green liquid crystal layer 14G, and a red liquid crystal layer 14R) and a light-absorbing layer 16, arranged in this order from the observer side (the top side in the drawing). Each liquid crystal layer 14 has a top transparent substrate 18, a bottom transparent substrate 20 that is aligned parallel to the top transparent substrate 18 with a prescribed distance therebetween, and liquid crystal 22 housed therebetween. In this embodiment, transparent glass plates are used for the transparent substrates, and memory type liquid crystal (such as chiral nematic liquid crystal) is used for the liquid crystal, but the application area of the present invention is not limited by this construction.

The top transparent substrate 18 has multiple (n number in this embodiment) belt-shaped transparent electrodes (scanning line electrodes, i.e., row electrodes) that are aligned parallel to each other and at prescribed intervals on the surface thereof that is in contact with the liquid crystal 22. At the same time, the bottom transparent substrate 20 has multiple (m number in this embodiment) belt-shaped transparent electrodes (data line electrodes, i.e., column electrodes) that are aligned parallel to each other and at prescribed intervals on the surface thereof that is in contact with the liquid crystal 22. Specifically, as shown in FIG. 2, the scanning line electrodes 24 and the data line electrodes 26 are aligned such that they are aligned in different directions, and in this embodiment, as seen by an observer, the scanning line electrodes 24 extend in the right/left direction and are aligned at prescribed intervals in the top/down direction, while the data line electrodes 26 extend in the top/down direction and are aligned at prescribed intervals in the right/left direction. The transparent electrodes are formed of indium tin oxide (ITO), as generally known to vendors in the art.

In this embodiment, the three liquid crystal layers 14 are stacked together such that the scanning line electrodes 24 and the data line electrodes 26 of each liquid crystal layer 14 are not offset from one liquid crystal layer 14 to another in either the right/left or top/down directions. In other words, the first to n-th scanning line electrodes of the blue liquid crystal layer B are respectively located on the first to n-th scanning line electrodes of the green liquid crystal layer G, which are in turn respectively located on the first to n-th scanning line electrodes of the red liquid crystal layer R. Similarly, the first to m-th data line electrodes of the blue liquid crystal layer B are respectively located on the first to m-th data line electrodes of the green liquid crystal layer G, which are in turn respectively located on the first to m-th data line electrodes of the red liquid crystal layer R.

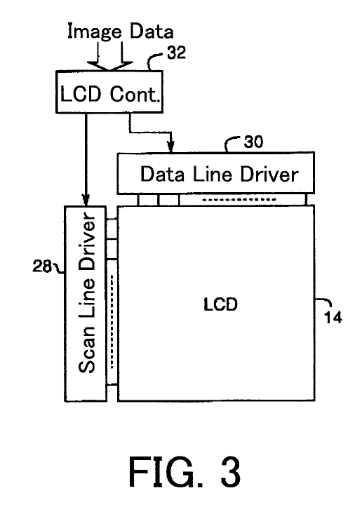

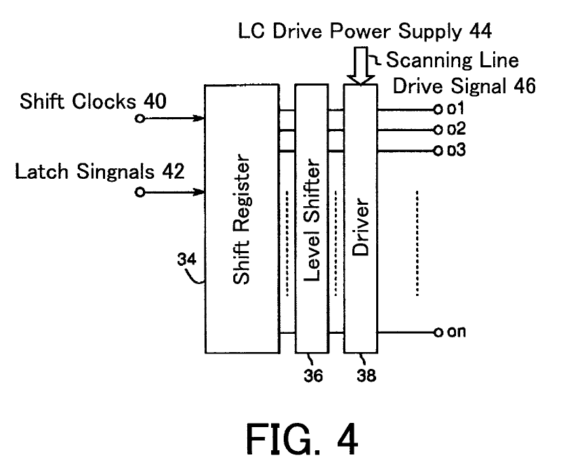

As shown in FIG. 3, each liquid crystal layer 14 has its own scanning line driver (scanning line drive circuit) 28 and data line driver (data line drive circuit) 30. The scanning line electrodes 24 and the data line electrodes 26 of each liquid crystal layer 14 are connected to their corresponding scanning line driver 28 and data line driver 30. These multiple scanning line drivers 28 and data line drivers 30 are connected to a common controller (control circuit) 32.

As shown in FIG. 4, each scanning line driver 28 comprises a shift register 34, a level shifter 36, and a driver 38. In response to a shift clock pulse 40 and a latch signal 42 transmitted from the controller 32, a prescribed voltage (a scanning line drive voltage 46) supplied from the liquid crystal drive power supply 44 is impressed to a desired scanning line electrode 24. The specific operation of the scanning line driver 28 is explained in detail below.

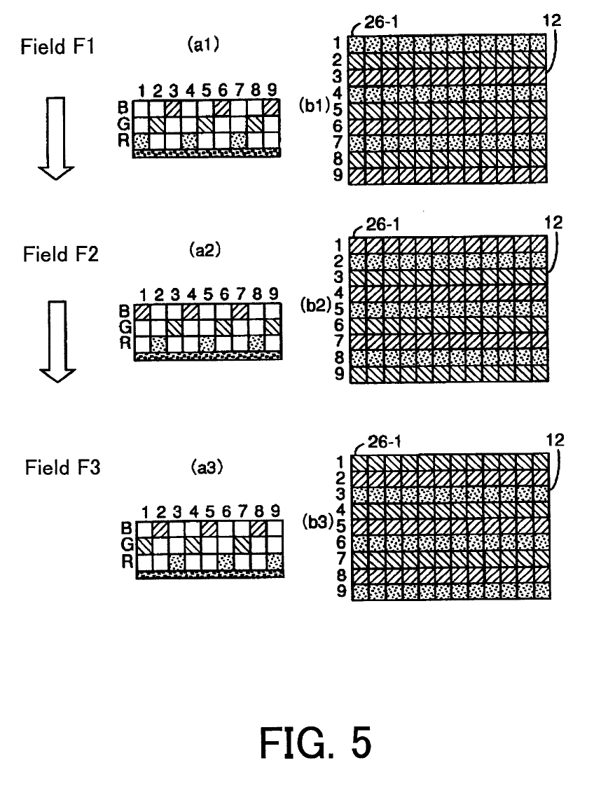

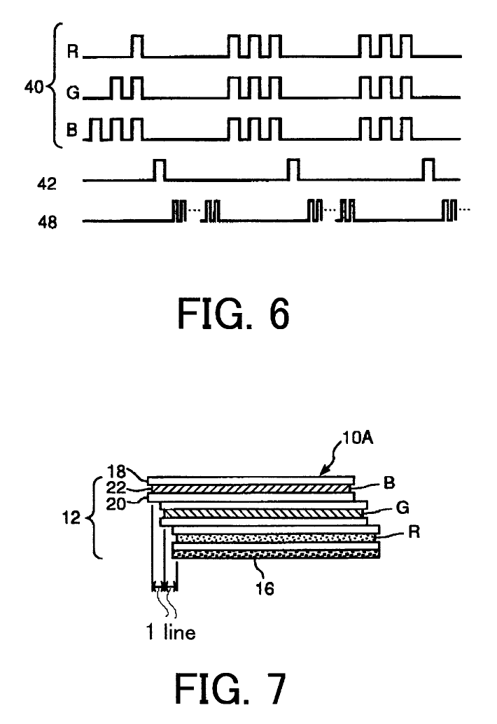

The interlace driving of the liquid crystal display element 12 will now be explained with reference to FIGS. 5 and 6. In order to simplify the explanation, each liquid crystal layer 14 is assumed to have nine scanning line electrodes. In addition, in the explanation below, the expression (N, M) indicates a pixel that is displayed at the point at which the N-th scanning line electrode and the M-th data line electrode intersect. Further, in this interlace driving, one frame is divided into three fields (each representing ⅓ of the frame). The scanning lines (the first to ninth scanning lines) of each liquid crystal layer 14 are assigned to the three fields F1, F2 and F3, such that they have the relationships shown in Table 1 below.

TABLE 1

| | Field | | |
|---|---|---|---|
| Liquid | F1 scanning | F2 scanning | F3 scanning |
| crystal | line row | line row | line row |
| layer | number | number | number |
| Red: R | 1, 4, 7 | 2, 5, 8 | 3, 6, 9 |
| Green: G | 2, 5, 8 | 3, 6, 9 | 1, 4, 7 |
| Blue: B | 3, 6, 9 | 1, 4, 7 | 2, 5, 8 |

(a1) through (a3) and (b1) through (b3) of FIG. 5 show the scanning lines that are driven (i.e., are impressed with a scanning line drive voltage 46) in the three fields F1, F2 and F3. The hatched area indicates a driven scanning line. Specifically, as shown in (a1) and (b1) of FIG. 5, in the first field F1, the first, fourth and seventh scanning line electrodes are sequentially driven in the red liquid crystal layer R, the second, fifth and eighth scanning line electrodes are sequentially driven in the green liquid crystal layer G, and the third, sixth and ninth scanning line electrodes are sequentially driven in the blue liquid crystal layer B. Therefore, for example, where a data line drive voltage is being impressed to the first data line electrodes 26 (26-1) from the data line drivers 30, the molecular orientation of the liquid crystal areas corresponding to the pixels (1, 1), (4, 1) and (7, 1) at which the data line electrode 26 and the first, fourth and seventh scanning line electrodes 24 of the red liquid crystal layer R intersect changes, causing these areas to become transparent. When this occurs, the first, fourth and seventh lines of the green liquid crystal layer G and the blue liquid crystal layer B are in the reflection state, such that when seen from the side of the observer, the first, fourth and seven scanning lines selectively reflect green and blue. The molecular orientation of the liquid crystal areas corresponding to the pixels (2,1), (5, 1) and (8, 1) at which the data line electrode 26 and the second, fifth and eighth scanning line electrodes 24 of the green liquid crystal layer G intersect changes, causing these areas to become transparent. When this occurs, the second, fifth and eighth lines of the red liquid crystal layer R and the blue liquid crystal layer B are in the reflection state, such that when seen from the side of the observer, the second, fifth and eighth scanning lines selectively reflect red and blue. Furthermore, the molecular orientation of the liquid crystal areas corresponding to the pixels (3, 1), (6, 1) and (9, 1) at which the data line electrode 26 and the third, sixth and ninth scanning line electrodes 24 of the blue liquid crystal layer B intersect changes, causing these areas to become transparent. When this occurs, the third, sixth and ninth lines of the green liquid crystal layer G and the red liquid crystal layer R are in the reflection state, such that when seen from the side of the observer, the third, sixth and ninth scanning lines selectively reflect green and red.

Next, as shown in (a2) and (b2) of FIG. 5, in the field F2, the second, fifth and eighth scanning line electrodes are sequentially driven in the red liquid crystal layer R, the third, sixth and ninth scanning line electrodes are sequentially driven in the green liquid crystal layer G and the first, fourth and seventh scanning line electrodes are sequentially driven in the blue liquid crystal layer B. Therefore, where a data line drive voltage is being impressed to the first data line electrodes 26 from the data line drivers 30, for example, the molecular orientation of the liquid crystal areas corresponding to the pixels (2, 1), (5, 1) and (8, 1) at which the data line electrode 26 and the second, fifth and eighth scanning line electrodes 24 of the red liquid crystal layer R intersect changes, causing these areas to become transparent. When this occurs, the second, fifth and eighth lines of the green liquid crystal layer G and the blue liquid crystal layer B are in the reflection state, such that when seen from the side of the observer, the second, fifth and eighth scanning lines selectively reflect green and blue. The molecular orientation of the liquid crystal areas corresponding to the pixels (3, 1), (6, 1) and (9, 1) at which the data line electrode 26 and the third, sixth and ninth scanning line electrodes 24 of the green liquid crystal layer G intersect changes, causing these areas to become transparent. When this occurs, the third, sixth and ninth lines of the red liquid crystal layer R and the blue liquid crystal layer B are in the reflection state, such that when seen from the side of the observer, the third, sixth and ninth scanning lines selectively reflect red and blue. Further, the molecular orientation of the liquid crystal areas corresponding to the pixels (1, 1), (4, 1) and (7, 1) at which the data line electrode 26 and the first, fourth and seventh scanning line electrodes 24 of the blue liquid crystal layer B intersect changes, causing these areas to become transparent. When this occurs, the first, fourth and seventh lines of the green liquid crystal layer G and the red liquid crystal layer R are in the reflection state, such that when seen from the side of the observer, the first, fourth and seventh scanning lines selectively reflect green and red.

Subsequently, as shown in (a3) and (b3) of FIG. 5, in the field F3, the third, sixth and ninth scanning line electrodes are sequentially driven in the red liquid crystal layer R, the first, fourth and seventh scanning line electrodes are sequentially driven in the green liquid crystal layer G, and the second, fifth and eighth scanning line electrodes are sequentially driven in the blue liquid crystal layer B. Therefore, for example, where a data line drive voltage is being impressed to the first data line electrodes 26 from the data line drivers 30, the molecular orientation of the liquid crystal areas corresponding to the pixels (3,1), (6, 1) and (9, 1) at which the data line electrode 26 and the third, sixth and ninth scanning line electrodes 24 of the red liquid crystal layer R intersect changes, causing these areas to become transparent. When this occurs, the third, sixth and ninth lines of the green liquid crystal layer G and the blue liquid crystal layer B are in the reflection state, such that when seen from the side of the observer, the third, sixth and ninth scanning lines selectively reflect green and blue. The molecular orientation of the liquid crystal areas corresponding to the pixels (1,1), (4, 1) and (7, 1) at which the data line electrode 26 and the first, fourth and seventh scanning line electrodes 24 of the green liquid crystal layer G intersect changes, causing these areas to become transparent. When this occurs, the first, fourth and seventh lines of the red liquid crystal layer R and the blue liquid crystal layer B are in the reflection state, such that when seen from the side of the observer, the first, fourth and seventh scanning lines selectively reflect red and blue. Further, the molecular orientation of the liquid crystal areas corresponding to the pixels (2,1), (5, 1) and (8, 1) at which the data line electrode 26 and the second, fifth and eighth scanning line electrodes 24 of the blue liquid crystal layer B intersect changes, causing these areas to become transparent. When this occurs, the second, fifth and eighth lines of the green liquid crystal layer G and the red liquid crystal layer R are in the reflection state, such that when seen from the side of the observer, the second, fifth and eighth scanning lines selectively reflect green and red.

The processing for the fields F1, F2 and F3 described above is thereafter repeatedly carried out.

The driving of the scanning line drivers 28 in the above interlace driving will be explained with reference to FIG. 6. In the drawing, the scanning line shift clock comprises pulses that are input to the shift registers 34 of the red liquid crystal layer R, the green liquid crystal layer G and the blue liquid crystal layer B. In each frame, one shift clock pulse is input to the shift register 34 of the red liquid crystal layer R, two shift clock pulses are input to the shift register 34 of the green liquid crystal layer G and three shift clock pulses are input to the shift register 34 of the blue liquid crystal layer B. A scanning line latch signal 42 is then input to the shift registers 34 of each liquid crystal layer 14. Consequently, the scanning line driver 28 of the red liquid crystal layer R impresses a scanning line drive signal 46 to the scanning line electrode 24 having the row number corresponding to the number of shift clock pulses input before the input of the scanning line latch signal 42. In other words, a scanning line drive signal 46 is impressed to the first scanning line electrode 24 in the red liquid crystal layer R while a scanning line drive signal 46 is impressed to the second scanning line electrode 24 in the green liquid crystal layer G and to the third scanning line electrode 24 in the blue liquid crystal layer B, respectively. Furthermore, in accordance with the image signals, a data line drive signal 48 is impressed to the data line electrodes 26 in each liquid crystal layer 14.

Three shift clock pulses are then input to the shift registers 34 of the red liquid crystal layer R, the green liquid crystal layer G and the blue liquid crystal layer B, respectively. A scanning line latch signal 42 is also input to the shift register 34 of each liquid crystal layer 14. Consequently, the scanning line driver 28 of each liquid crystal layer 14 impresses a scanning line drive signal 46 to the scanning line electrode 24 having the row number corresponding to the number of shift clock pulses input before the input of the scanning line latch signal 42. In other words, a scanning line drive signal 46 is impressed to the fourth scanning line electrode 24 in the red liquid crystal layer R while a scanning line drive signal 46 is impressed to the fifth scanning line electrode 24 in the green liquid crystal layer G and to the sixth scanning line electrode 24 in the blue liquid crystal layer B, respectively. Furthermore, in accordance with the image signals, a data line drive signal 48 is impressed to the data line electrodes 26 in each liquid crystal layer 14.

Three shift clock pulses are then input once more to the shift registers 34 of the red liquid crystal layer R, the green liquid crystal layer G and the blue liquid crystal layer B, respectively. A scanning line latch signal 42 is also input to the shift register 34 of each liquid crystal layer 14. Consequently, a scanning line drive signal 46 is impressed to the seventh scanning line electrode 24 in the red liquid crystal layer R while a scanning line drive signal 46 is impressed to the eighth scanning line electrode 24 in the green liquid crystal layer G and to the ninth scanning line electrode 24 in the blue liquid crystal layer B, respectively. Furthermore, in accordance with the image signals, a data line drive signal 48 is impressed to the data line electrodes 26 in each liquid crystal layer 14.

As described above, using the liquid crystal apparatus 10 of the above embodiment, in each field when the interlace method is adopted in the liquid crystal apparatus, the scanning line to which a scanning line drive signal is being impressed becomes transparent, but because the scanning lines of the other liquid crystal layers (the scanning lines of the other liquid crystal layers located above or below the scanning line to which a scanning line drive signal is being impressed) are not being impressed with a scanning line drive signal, they are in the reflection state. In other words, two colors are reflected in all areas corresponding to the scanning lines, so that the color (usually black) of the light absorbing layer, which is supporting the three liquid crystal layers, does not appear in the background, and high-quality, easily viewable images may be obtained.

Embodiment 2

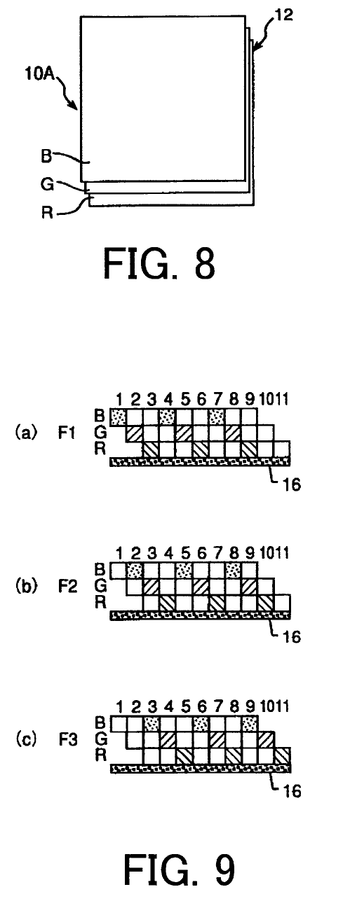

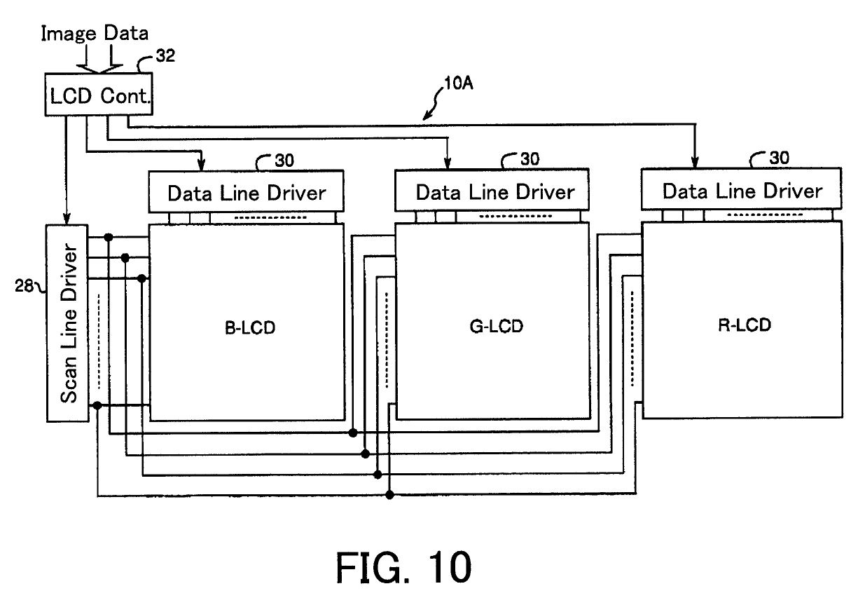

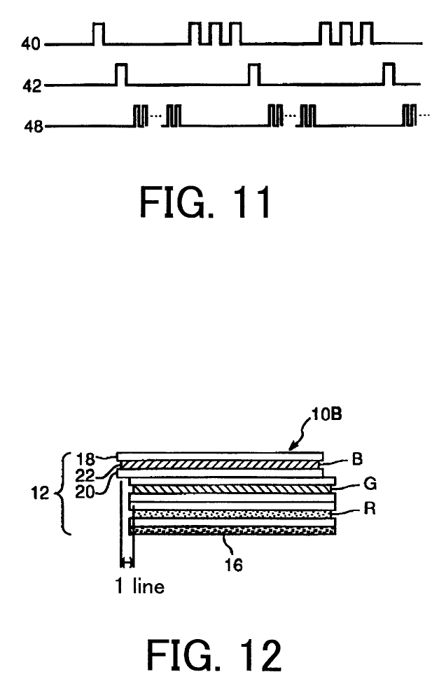

FIGS. 7 through 11 show a liquid crystal apparatus 10A comprising an embodiment 2. In this liquid crystal apparatus 10A, the three liquid crystal layers 14 are placed such that they are offset from each other by one scanning line electrode 24. Specifically, the first to nth scanning line electrodes of the bottommost red liquid crystal layer R are located below the second to n+1th scanning line electrodes of the middle green liquid crystal layer G, and the first to nth scanning line electrodes of the middle green liquid crystal layer G are located below the second to n+1th scanning line electrodes of the topmost blue liquid crystal layer B. In addition, as shown in FIG. 10 in particular, the three liquid crystal layers 14 are connected to a single scanning line driver 28.

Using the liquid crystal apparatus 10A of the embodiment 2, one frame is divided into three fields, as shown in FIG. 9. In the first field, a scanning line shift clock pulse 40 is first supplied to the scanning line driver 28 from the controller 32, and a scanning line latch signal 42 is then supplied. Consequently, the scanning line driver 28 sequentially impresses a scanning line drive voltage to the first scanning line electrodes of the three liquid crystal layers 14, as shown in FIG. 9(a). Because the three liquid crystal layers 14 are offset from each other by one scanning line electrode, in the green liquid crystal layer G, a scanning line drive voltage is impressed to the scanning line below the second line of the blue liquid crystal layer B. In the red liquid crystal layer R, a scanning line drive voltage is impressed to the scanning line below the third line of the blue liquid crystal layer B.

Three scanning line shift clock pulses 40 are then supplied to the scanning line driver 28 from the controller 32, followed by a scanning line latch signal 42. Consequently, the scanning line driver 28 impresses a scanning line drive voltage 46 to the fourth scanning line electrode of the blue liquid crystal layer B, as well as to the green liquid crystal layer's scanning line below the fifth line of the blue liquid crystal layer B and the red liquid crystal layer's scanning line below the sixth line of the blue liquid crystal layer B.

Three scanning line shift clock pulses 40 are then supplied to the scanning line driver 28 from the controller 32, followed by a scanning line latch signal 42. Consequently, the scanning line driver 28 impresses a scanning line drive voltage to the seventh scanning line electrode of the blue liquid crystal layer B, as well as to the green liquid crystal layer's scanning line below the eighth line of the blue liquid crystal layer B and the red liquid crystal layer's scanning line below the ninth line of the blue liquid crystal layer B.

In the second field, the scanning line driver 28 impresses a scanning line drive voltage to the second scanning line of the blue liquid crystal layer B, as well as to the green liquid crystal layer's scanning line below the third line of the blue liquid crystal layer B and the red liquid crystal layer's scanning line below the fourth line of the blue liquid crystal layer B, as shown in FIG. 9(b).

The scanning line driver 28 then impresses a scanning line drive voltage to the fifth scanning line electrode of the blue liquid crystal layer B, as well as to the green liquid crystal layer's scanning line below the sixth line of the blue liquid crystal layer B and the red liquid crystal layer's scanning line below the seventh line of the blue liquid crystal layer B.

The scanning line driver 28 then impresses a scanning line drive voltage to the eighth scanning line electrode of the blue liquid crystal layer B, as well as to the green liquid crystal layer's scanning line below the ninth line of the blue liquid crystal layer B and the red liquid crystal layer's scanning line below the tenth line (which is a virtual line that does not exist in actuality) of the blue liquid crystal layer B.

In the third field, the scanning line driver 28 impresses a scanning line drive voltage to the third scanning line of the blue liquid crystal layer B, as well as to the green liquid crystal layer's scanning line below the fourth line of the blue liquid crystal layer B and the red liquid crystal layer's scanning line below the fifth line of the blue liquid crystal layer B, as shown in FIG. 9(c).

The scanning line driver 28 then impresses a scanning line drive voltage to the sixth scanning line electrode of the blue liquid crystal layer B, as well as to the green liquid crystal layer's scanning line below the seventh line of the blue liquid crystal layer B and the red liquid crystal layer's scanning line below the eighth line of the blue liquid crystal layer B.

The scanning line driver 28 then impresses a scanning line drive voltage to the ninth scanning line electrode of the blue liquid crystal layer B, as well as to the green liquid crystal layer's scanning line below the tenth line (which is a virtual line that does not exist in actuality) of the blue liquid crystal layer B and the red liquid crystal layer's scanning line below the eleventh line (which is a virtual line that does not exist in actuality) of the blue liquid crystal layer B.

An image for one frame is displayed in this manner, and the above processing is repeatedly carried out for the subsequent frames as well. As described above, because in the liquid crystal apparatus 10A of the embodiment 2, the three liquid crystal layers 14 are offset from each other by one scanning line, the three liquid crystal layers 14 may be simultaneously driven by a single scanning line driver, and the construction of the drive circuit may be made simpler than that in the liquid crystal apparatus 10A of the embodiment 1.

Embodiment 3

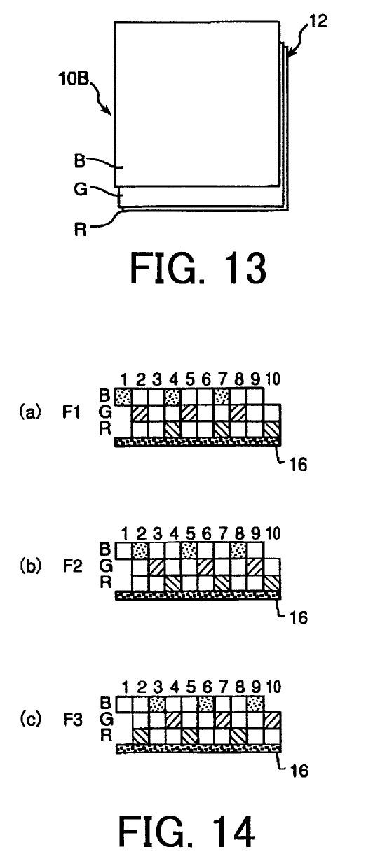

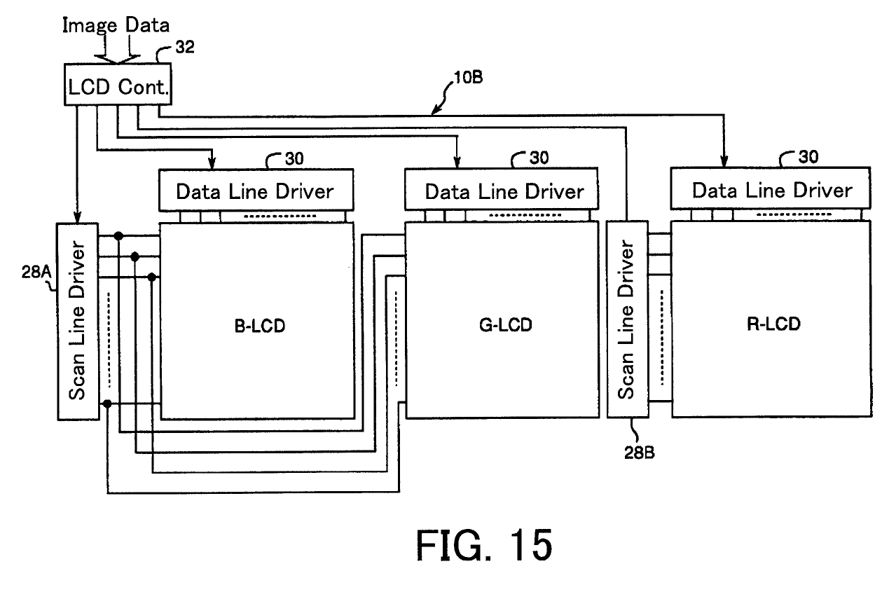

FIGS. 12 through 16 show a liquid crystal apparatus 10B comprising an embodiment 3. In this liquid crystal apparatus 10B, as shown in FIGS. 12 through 14, the blue liquid crystal layer B that comprises the first group is placed such that it is offset from the green liquid crystal layer G by one scanning line electrode 24. However, the green liquid crystal layer G and the red liquid crystal layer R comprising the second group match, i.e., are perfectly aligned with each other. As shown in FIG. 15, the blue liquid crystal layer B and the green liquid crystal layer G are connected to one scanning line driver 28A, while the red liquid crystal layer R is connected to a different scanning line driver 28B.

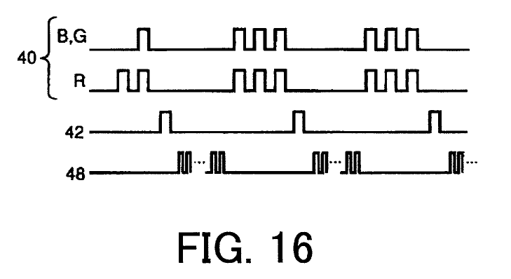

Using this liquid crystal apparatus 10B of the embodiment 3, as shown in FIG. 14, one frame is divided into three fields (shown in (a) through (c) of FIG. 14). During driving, in the first field, a scanning line shift clock pulse is supplied to the scanning line driver 28A from the controller 32, as shown in FIG. 16. Two scanning line shift clock pulses are also supplied to the scanning line driver 28B from the controller 32. A scanning line latch signal is then supplied to the scanning line drivers 28A and 28B, respectively, from the controller 32. Consequently, the scanning line driver 28A impresses a scanning line drive voltage to the first scanning line of the blue liquid crystal layer B, as shown in FIG. 14(a). At the same time, the scanning line driver 28A also impresses a scanning line drive voltage to the green liquid crystal layer's scanning line below the second line of the blue liquid crystal layer B. The scanning line driver 28B impresses a scanning line drive voltage to the red liquid crystal layer's scanning line below the third line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the fourth scanning line electrode of the blue liquid crystal layer B, as well as to the green liquid crystal layer's scanning line below the fifth line of the blue liquid crystal layer B. The scanning line driver 28B impresses a scanning line drive voltage to the red liquid crystal layer's scanning line below the sixth line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the seventh scanning line electrode of the blue liquid crystal layer B, as well as to the green liquid crystal layer's scanning line below the eighth line of the blue liquid crystal layer B. The scanning line driver 28B impresses a scanning line drive voltage to the red liquid crystal layer's scanning line below the ninth line of the blue liquid crystal layer B.

In the second field, the scanning line driver 28A impresses a scanning line drive voltage to the second scanning line of the blue liquid crystal layer B, as well as to the green liquid crystal layer's scanning line below the third line of the blue liquid crystal layer B, as shown in FIG. 14(b). The scanning line driver 28B impresses a scanning line drive voltage to the red liquid crystal layer's scanning line below the fourth line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the fifth scanning line electrode of the blue liquid crystal layer B, as well as to the green liquid crystal layer's scanning line below the sixth line of the blue liquid crystal layer B. The scanning line driver 28B impresses a scanning line drive voltage to the red liquid crystal layer's scanning line below the seventh line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the eighth scanning line electrode of the blue liquid crystal layer B, as well as to the green liquid crystal layer's scanning line below the ninth line of the blue liquid crystal layer B. The scanning line driver 28B impresses a scanning line drive voltage to the red liquid crystal layer's scanning line below the tenth line (which is a virtual line that does not exist in actuality) of the blue liquid crystal layer B.

In the third field, the scanning line driver 28A impresses a scanning line drive voltage to the third scanning line of the blue liquid crystal layer B, as well as to the green liquid crystal layer's scanning line under the fourth line of the blue liquid crystal layer B, as shown in FIG. 14(c). The scanning line driver 28B impresses a scanning line drive voltage to the red liquid crystal layer's scanning line below the fifth line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the sixth scanning line electrode of the blue liquid crystal layer B, as well as to the green liquid crystal layer's scanning line below the seventh line of the blue liquid crystal layer B. The scanning line driver 28B impresses a scanning line drive voltage to the red liquid crystal layer's scanning line below the eighth line of the blue liquid crystal layer B.

Three scanning line shift clock pulses are then supplied to the scanning line drivers 28A and 28B, respectively, from the controller 32, followed by a scanning line latch signal. Consequently, the scanning line driver 28A impresses a scanning line drive voltage to the ninth scanning line electrode of the blue liquid crystal layer B, as well as to the green liquid crystal layer's scanning line below the tenth line (which is a virtual line that does not exist in actuality) of the blue liquid crystal layer B. The scanning line driver 28B impresses a scanning line drive voltage to the red liquid crystal layer's scanning line below the eleventh line (which is a virtual line that does not exist in actuality) of the blue liquid crystal layer B.

An image for one frame is displayed in this manner. The above processing is repeatedly carried out for the subsequent frames as well. Because the two liquid crystal layers B and G are offset from each other by one scanning line in this liquid crystal apparatus 10B of the embodiment 3, the two liquid crystal layers B and G may be simultaneously driven by a single scanning line driver, and the construction of the drive circuit may be made simpler than in the liquid crystal apparatus 10 of the embodiment 1.

As is clear from the above description, because the liquid crystal apparatuses pertaining to the embodiments 1 through 3 are constructed such that different fields of the three display layers are redrawn at a given time, even during redraw of the display image, an area corresponding to any particular scanning line is in a state in which two colors are reflected. Consequently, even during redraw of the display image, the color (usually black) of the light absorbing layer that supports the three liquid crystal layers does not appear in the background, and thereby images that are easy to view may be obtained.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A liquid crystal display apparatus comprising:
a liquid crystal display element having a plurality of liquid crystal layers each having a plurality of display units that are arranged in a matrix fashion and are defined by intersections of a plurality of scanning line electrodes and a plurality of data line electrodes, said liquid crystal layers being stacked each other such that said scanning line electrodes and said data line electrodes of any one of said liquid crystal layers match said scanning line electrodes and said data line electrodes of the other ones of said liquid crystal layers whereby a plurality pixels are formed by the display units of each liquid crystal layer that overlap with each other; and
a controller for, when an image is drawn in said liquid crystal display element, selecting at least one of the matching scanning line electrodes of said liquid crystal layers at a different timing than that used for the other matching scanning line electrodes, such that the all of the matching scanning line electrodes of said liquid crystal layers are not simultaneously selected.

2. A liquid crystal display apparatus according to claim 1, wherein said controller includes:
a drive circuit connected with said scanning line electrodes of one of said plurality of liquid crystal layers; and
wirings that respectively connect said scanning line electrodes of the one of said liquid crystal layers with said scanning line electrodes of at least one of the remaining ones of said liquid crystal layers.

3. A liquid crystal display apparatus according to claim 2, wherein said controller wherein said driver circuit is shared by all of said liquid crystal layers.

4. A liquid crystal display apparatus according to claim 1, wherein at least one of said liquid crystal layers is placed so as to be offset from the other ones of said liquid crystal layers by one scanning line electrode in the direction of the arrangement thereof.

5. A liquid crystal display apparatus according to claim 1, wherein said controller is adapted to select each of the matching scanning line electrodes of the multiple liquid crystal layers at different timings.

6. A liquid crystal display apparatus according to claim 1, wherein said controller splits said liquid crystal layers into multiple fields for driving.

7. A liquid crystal display apparatus comprising:
a liquid crystal display element comprising a plurality of liquid crystal layers that are stacked each other;
a drive circuit for driving the liquid crystal layers; and
a control unit that is connected to said drive circuit and is adapted to update information displayed on said liquid crystal display element by using an interlaced scanning method that divides each liquid crystal layer into a plurality of fields and sequentially drives the fields of each liquid crystal layer, wherein said control unit controls said driver so that a driven field of at least one of said liquid crystal layers different from those of the other of said liquid crystal layers.

8. A liquid crystal display apparatus according to claim 7, wherein said liquid crystal display element comprises n (n is a natural number not less than 2) liquid crystal layers, and wherein said control unit divides each liquid crystal layer into n fields.

9. A liquid crystal display apparatus according to claim 8, wherein n is three.

10. A liquid crystal display apparatus according to claim 9, wherein said n liquid crystal layers comprise a first liquid crystal tuned to reflect light of blue, a second liquid crystal tuned to reflect light of green, and a third liquid crystal tuned to reflect light of red, respectively.
